(19) United States
(12) Patent Application Publication
(10) Pub. No.: US 2005/0135754 A1
(43) Pub. Date: Jun. 23, 2005

(54) Clamshell ferrule to avoid fiber threading

(76) Inventor: Kunchuan Chiang, Antioch, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/742,712

(22) Filed: Dec. 19, 2003

(51) Int. Cl. G02B 6/36

(52) U.S. Cl. 385/78

(57) ABSTRACT

A clamshell ferrule may comprise a bottom portion having a narrower flange at one end. A groove runs the length of the bottom portion and the flange. The groove may be sized to accommodate and optical fiber 36. No fiber threading is necessary with the clamshell design since the optical fiber may simply be laid inside of the groove and a top portion, which may be the mirror image of the bottom portion, used to sandwich the optical fiber. Once the fiber is threaded into the feed through aperture or snout of an optical module and secured, the top and bottom portions may simply be separated thus releasing the fiber from the ferrule without the need for reversed threading.

### FIELD OF THE INVENTION

Embodiments of the present invention are directed to optical modules and, more particularly, to ferrule designs to avoid the fiber threading.

### BACKGROUND INFORMATION

Fiber optics are used for a great number of applications. Everything from communication and computing systems, test and measurement systems, and medical systems and devices make use of optical technology. Optical devices are becoming increasingly smaller and more fragile.

In particular, fiber optic telecommunications are continually subject to demand for increased bandwidth. One way that bandwidth expansion has been accomplished is through dense wavelength division multiplexing (DWDM) wherein multiple separate data streams exist concurrently in a single optical fiber, with modulation of each data stream occurring on a different channel. Each data stream is modulated onto the output beam of a corresponding semiconductor transmitter laser operating at a specific channel wavelength, and the modulated outputs from the semiconductor lasers are combined onto a single fiber for transmission in their respective channels.

Optical modules are the critical components for the optic communication system. To keep the module reliability over service life, hermetic optical modules are required to keep away the moisture migration and other contaminant, which degrade the optic module performance.

A typical hermetic module is a Kovar can with all electrical and optical parts inside and with a Kovar lid that is resistance welded by seam sealer. A hermetic fiber feedthrough is a common way to passing light through a hermetic optic module.

A hermetic fiber feedthrough is created by the glass or metallic solder sealed to the fiber. A ferrule is used in solder reflow process to maintain the fiber concentricity and to avoid the fiber bending.

The cylindrical ferrule is manually threaded through the fiber. After the placement of solder, a seal is formed coaxial with the fiber and the feed-through aperture thus hermetically sealing the package.

It may be desirable to provide a hermetically fiber feedthrough, which does not require fiber threading.

### BRIEF DESCRIPTION OF THE DRAWINGS

FIG. 1 is a diagram of an optical module having a fiber feed-through and traditional threading ferrule;

FIG. 2 is a diagram of a the bottom portion of the clamshell ferrule according to one embodiment of the invention; and

FIG. 3 a diagram of an optical module and clamshell ferrule according to an embodiment of the invention for avoiding fiber threading.

### DETAILED DESCRIPTION

In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

FIG. 1 shows an optical module 10 which may contain optical and electrical components. The module 10 may be hermetically sealed to protect the contents for outside contaminants. The module 10 may comprise a bottom portion 12 which is essentially a container having a bottom and vertical sides. Electrical leads 14 are shown extending from the bottom 12 of the module 10 to provide electrical inputs and/or outputs to the various components in the module 10. A lid 16 fits over the bottom 12 and may be hermetically sealed such as by laser welding or a solder process.

A generally cylindrical fiber feed through or “snout” 17 projects from the front of the module 10 to provide an opening for inserting an optical fiber 18 to provide an optical input/output to the module 10. The optical fiber 18 is generally a thin, relatively fragile strand that must be threaded through snout 17 and aligned with optics in the module 10. Normally, the lid 16 would be off during the alignment process to gain access to the components inside.

In order to maintain the concentricity of the fiber 18 in the snout 17 during solder reflowing process, a ferrule 20 may be used. The ferrule 20 may also be generally cylindrical in shape and sized to fit within the snout 17. A front end 24 of the fiber 18 is threaded through the ferrule 20 and protrudes from the ferrule 20 to be aligned with optics within the module 10. The ferrule 20 may then be inserted into the snout 17 and the end of the fiber 18 aligned and secured within the module 10. A stop 22 limits the length of the ferrule 20 that may be inserted into the snout 17. Since this threading process is usually done by hand, the stop 22 also provides a convenient grip for handling the ferrule 20. After the solder reflowing process, the ferrule 20 must be removed by reverse threading it all the way along the entire length of the fiber 18. Since the fiber is fragile, it may be prone to damage during reverse threading. Further, threading tends to be more difficult for longer fibers 18. Thereafter, the lid 16 may be placed on the bottom 12 of the module 10 and a hermetic seal made there between. The snout 17 further comprises an opening 26 through which a hermetic seal may be made by, for example, glass or metallic solder reflow, to seal the area between the fiber 18 and the inner diameter of the snout 17.

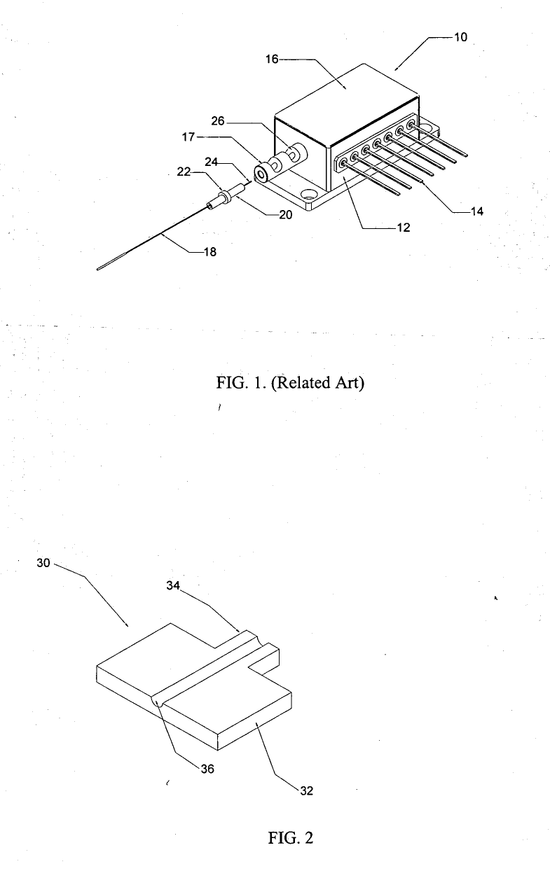

FIG. 2 shows the bottom portion of the clamshell ferrule 30 according to an embodiment of the invention. The clamshell ferrule 30 may comprise a base or bottom portion 32 having a narrower flange portion 34 at one end. The bottom portion may comprise a generally flat top surface having a groove 36 that runs the length of the bottom portion 32 and the flange 34. The groove 36 may be sized to accommodate and optical fiber 36. Unlike the ferrule 10 shown in FIG. 1, no threading is necessary with the clamshell design since the optical fiber may simply be laid inside of the groove.

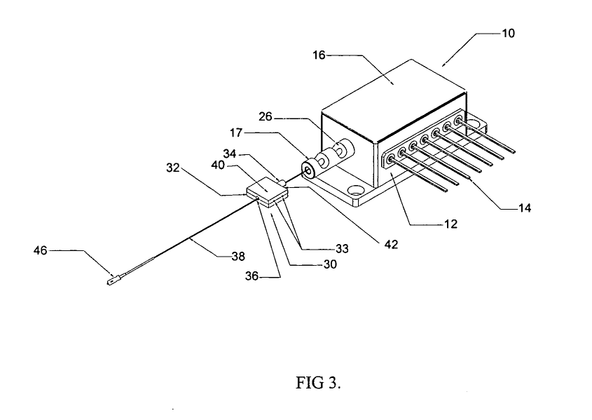

Referring now to FIG. 3, the clamshell ferrule 30 further comprises a lid 40 which may be a mirror image of the bottom portion 32. The lid 40 may be simply fitted over the bottom 32 or optionally may be hinged with hinges 33 for easier handling. The optical fiber 38 may be laid in the groove 36 and sandwiched between the bottom portion 32 and the lid portion 40. The optical module 10 shown for illustration may be the same as that shown and described with reference to FIG. 1 with like reference numerals indicating like features. As shown, the ferrule 30 may be substantially rectangular in shape and provides a convenient grip for handling the fiber 38. Of course, while a rectangular ferrule 30 is shown, the body of the ferrule 30 may be any convenient shape. The leading edge 42 of the ferrule 30 acts as a stop allowing the flange 34 to penetrate the snout 17 only as far as prior to the opening 26. The leading edge of the fiber 38 may then be aligned and secured within the module 10. The lid 40 may then be placed on the bottom 32 and sealed such as by laser welding or with solder. Similarly, the opening 26 may be used through which a hermetic seal may be made by, for example, glass or metallic solder reflow, to seal the area between the fiber 38 and the inner diameter of the snout 17.

The ferrule 30 may then be pulled backward slightly so that the flange 34 slips out of the snout 17. The lid 40 of the ferrule 30 may then be lifted from the bottom 32 of the ferrule 30 to release the fiber 38. This avoids the need to reverse thread the ferrule 30 all the way down the length of the fiber 38. In addition, unlike the ferrule 20 shown in FIG. 1, a pre-connectorized fiber may be used (e.g., a fiber having a connector 46 at its terminal end) according to embodiments of the invention. This is not possible with the ferrule 20 of FIG. 1 since the ferrule 20 can not be threaded past the connector 46.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1. A ferrule, comprising:
a ferrule bottom having a generally flat top surface;
a flange portion positioned at a leading end of said ferrule bottom;
a groove running down the length of said ferrule bottom and said flange portion;
a ferrule lid substantially a mirror image of said ferrule bottom to fit over said ferrule bottom.

2. The ferrule of claim 1, further comprising:
a hinge to connect the ferrule bottom to the ferrule lid.

3. The ferrule as recited in claim 1, wherein said groove is shaped to accommodate an optical fiber.

4. The ferrule as recited in claim 3 wherein said flange portion is shaped to fit into a snout of an optical module.

5. The ferrule as recited in claim 4 wherein said leading edge comprises a stop to limit the position of said flange portion within said snout.

6. The ferrule as recited in claim 1 wherein said bottom portion and said lid portion comprise a grip.

7. The ferrule as recited in claim 1 wherein said bottom portion and said lid portion are generally rectangular.

8. A method, comprising:
providing a ferrule having a bottom portion and a lid portion;
sandwiching an optical fiber in a groove between said bottom portion and said lid portion of said ferrule;
inserting a flange of said ferrule into a snout of an optical module;
securing an end of said optical fiber within said module;
sealing an area between an inner diameter of said snout and said optical fiber;
pulling said flange portion from said snout; and
separating said lid portion from said bottom portion to release said optical fiber from said ferrule.

9. The method as recited in claim 8, further comprising:
hinging said bottom portion to said top portion.

10. The method as recited in claim 8 wherein said snout comprises an opening for said sealing.

11. The method as recited in claim 10 further comprising:
using a pre-connectorized optical fiber.

12. The method as recited in claim 9 further comprising:
using a stop to limit said inserting.

13. A system for sealing an optical fiber connected to an optical module, comprising:
a ferrule having a bottom portion and a mating top portion;
a groove running through said ferrule to accommodate an optical fiber sandwiched between said bottom portion and said top mating portion;
an optical module comprising a generally cylindrical snout;
a flange at a leading end of said ferrule to fit coaxial into said snout; and
an opening in a top of said snout to seal an area between the fiber and said an inner diameter of said snout.

14. The system as recited in claim 13, wherein said optical fiber comprises a pre-connectorized optical fiber.

15. The system as recited in claim 13, further comprising:
a hinge to connect said bottom portion and said top mating portion.

16. The system as recited in claim 13, wherein said ferrule comprises a grip area.

17. The system as recited in claim 16 wherein said grip area is generally rectangular.

18. The system as recited in claim 16 wherein a leading edge of said grip area comprises a stop.

19. The system as recited in claim 13 wherein said optical fiber is released from said ferrule by separating said top portion from said bottom portion.

20. The system as recited in claim 15 wherein said optical fiber is released from said ferrule by opening said top portion on said hinge.
